(19) United States
(12) Patent Application Publication
(10) Pub. No.: US 2010/0299289 A1
(43) Pub. Date: Nov. 25, 2010

(54) SYSTEM AND METHOD FOR OBTAINING INFORMATION ABOUT BIOLOGICAL NETWORKS USING A LOGIC BASED APPROACH

(75) Inventors: Rahul SIMHA, Springfield, VA (US); Guanyu Wang, Fairfax, VA (US); Chen Zeng, Rockville, MD (US)

Correspondence Address: BLANK ROME LLP, WATERGATE, 600 NEW HAMPSHIRE AVENUE, N.W., WASHINGTON, DC, 20037, US

(73) Assignee: The George Washington University, Washington, DC (US)

(21) Appl. No.: 12/783,849

(22) Filed: May 20, 2010

Related U.S. Application Data
(60) Provisional application No. 61/180,015, filed on May 20, 2009.

(51) Int. Cl. G06F 15/18; G06F 17/11

(52) U.S. Cl. 706/12

(57) ABSTRACT

A system and method of obtaining information concerning the structure-function relationship of biological networks can be studied holistically through the ensemble characterization of all the networks that realize a given biological function. A logic-based approach enables significant advances in computability and concept development (minimality and reducibility). The approach is applied to a biologically relevant trajectory and reveals some interesting properties. By using the approach, a cell cycle network is decomposed into three components with the functioning of each component explained.

### CROSS REFERENCE TO RELATED APPLICATIONS

This application claims the benefit of U.S. Provisional Application No. 61/180,015, filed May 20, 2009, the entire contents of which are incorporated herein by reference.

### FEDERALLY SPONSORED RESEARCH OR DEVELOPMENT

The work is supported by NSF CDI-0941228 (CZ, RS, YR, GW), the Project of Knowledge Innovation Program of Chinese Academy of Sciences (GW), DMR-0313129 from the National Science Foundation (CZ), and Grant No. 30525037 from the National Science Foundation of China (YX).

### BACKGROUND OF THE INVENTION

1. Field of the Invention

This invention relates to logic-based methods of studying structure-function relationships among biomolecules when their interactions are represented as a network of interactions and when the functional behavior of the network depends on the states of the individual molecules in the network. Using the present invention, the structure-function relationship of biological networks is studied holistically through the ensemble characterization of all the networks that realize a given biological function. Using this logic-based approach enables significant advances in computability and concept development (minimality and reducibility). An example is provided showing how the approach is successfully applied to a biologically relevant trajectory and reveals some interesting properties. As an example of its application, by using the approach, a cell cycle network is decomposed into three components with the functioning of each component explained.

2. Background of the Invention

The amount of biological information currently generated per unit time is increasing dramatically. It is estimated that the amount of information now doubles every four to five years. Because of the large amount of information that must be processed and analyzed, traditional methods of analyzing and understanding the meaning of information in the life science-related areas are breaking down. Statistical techniques, while useful, do not provide a biologically motivated explanation of function.

The history of development and understanding of biology has been fundamentally reductionist, in that knowledge has accumulated through the years by a process of experiment serving to hold certain variables constant and varying one or more others. This permits development of understanding of diverse biological elements and processes in isolation, but in some cases has led to a myopic understanding of biology principles divorced from their context within overwhelming complex systems. While this approach has been very successful, it recently has become increasingly appreciated that a systems based approach to analysis is required to achieve the next level of biological understanding.

To form an effective understanding of a biological system, a life science researcher must synthesize information from many sources. Understanding biological systems is made more difficult by the interdisciplinary nature of the life sciences, and may require in-depth knowledge of genetics, cell biology, biochemistry, medicine, and many other fields. Understanding a system may require that information of many different types be combined. Life science information may include material on basic chemistry, proteins, cells, tissues, and effects on organisms or population—all of which may be interrelated. These interrelations may be complex, poorly understood, or hidden within an ever accreting mountain of data.

There are ongoing attempts to produce electronic models of biological systems designed to facilitate biological analysis. These involve compilation and organization of enormous amounts of data, and construction of a system that can operate on the data to simulate the behavior of a biological system. Because of the complexity of biology, and the sheer numbers of data, the construction of such a system can take hundreds of man years and multiple tens of millions of dollars. Furthermore, those seeking new insights and new knowledge in the life sciences are presented with the ever more difficult task of selecting the right data from within mountains of information gleaned from vastly different sources. Companies willing to invest such resources so far have been unable to achieve breakthrough utility in development of a model which aids researchers in significantly advancing biological knowledge.

A central theme of biophysics is to reveal the relationship between structure and function [1-6]. Determining how all of the components within a network interact has historically been a difficult and time-consuming task. For a system of biomolecules, their network of interactions is the structure, and the resulting sequence of states of the molecules (whether active or not) is the function. Because any given function can be achieved by a multitude of networks, there arises the question of which network is chosen by nature, whether that network is efficient (has only the minimum needed edges), and why nature's choice of network, among the many that could achieve the same result, is useful.

A central challenge in systems biology today is to understand the network of interactions among biomolecules and, especially, the organizing principles underlying such networks. Recent analysis of known networks has identified small motifs that occur ubiquitously, suggesting that larger networks might be constructed in the manner of electronic circuits by assembling groups of these smaller modules.

Micro-biological networks are representations of biological processes involving transformation of molecular species through a sequence of interactions. Graphically, each biologically active kind of molecule is a “node,” and interactions between molecules is represented by connections called “edges.” A central theme in systems biology is to reveal the intricate relationship among network structure, dynamical properties, and biological function [2, 3, 4, 5, 19]. Consider for example the 11-molecule cell-cycle network model for the budding yeast cell described in [4] and shown here in FIG. 1(b). Even a modest sized network like this one captures important issues about the architecture of biological networks: what different parts of the network contribute to the network's function and its dynamic behavior; whether the same functionality be achieved with a smaller network (fewer edges); the effect a simpler network has on the biological stability (robustness); whether the network is irreducible, or if it can be described by an assemblage of smaller modules.

Prior work on network decomposition—understanding a network's components—has focused on two types of analysis. The first, which will be referred to here generally as motif occurrence analysis, examines all possible small motifs with two, three or four nodes and by searching for these motifs in known networks, identifies those motifs that occur most frequently across all known networks [20, 21, 22]. The assumption is that frequently occurring motifs then form a useful building block or module that confers some functionality or property. The second type of work, which will be referred to here generally as motif function analysis, focuses more closely on network function or dynamics. This approach starts with a given network and its known dynamic behavior (the function of the network) and, by removing the edges in a small motif, tries to characterize the effect of the motif. The thinking here is, if the removal of a motif results in a loss of function, the motif can be said to contribute to the function. Note that, because any subset of connected edges can be a plausible motif, the number of trials needed for a systematic search of all motifs grows exponentially large, a limitation that also afflicts the motif-occurrence approach. These approaches leave open the question of whether networks contain large motifs that are a primary determining factor in achieving a network's function.

U.S. Pat. No. 6,983,227, Virtual Models of Complex Systems, discloses a computer based virtual models of complex systems, together with integrated systems and methods provide a development and execution framework for visual modeling and dynamic simulation of said models.

U.S. Pat. No. 5,657,255, Hierarchical Biological Modelling System and Method, discloses a hierarchical biological modelling system and method that provides integrated levels of information synthesized from multiple sources. An executable model of a biological system is developed from information and structures based on the multiple sources. U.S. Pat. No. 7,415,359, Methods and Systems for the Identification of Components of Mammalian Biochemical Networks as Targets for Therapeutic Agents, discloses systems and methods that are presented for cell simulation and cell state prediction. For example, a cellular biochemical network intrinsic to a phenotype of a cell can be simulated by specifying its components and their interrelationships. The various interrelationships can be represented with one or more mathematical equations which can be solved to simulate a first state of the cell.

U.S. Pat. No. 7,319,945, Automated Methods for Simulating a Biological Network, discloses methods, computer systems, and computer programs for simulating a biological network.

U.S. Pat. No. 7,054,757, Method, System, and Computer program product for Analyzing Combinatorial Libraries, discloses in silico analysis of a virtual combinatorial library. Mapping coordinates for a training subset of products in the combinatorial library, and features of their building blocks, are obtained. A supervised machine learning approach is used to infer a mapping function f that transforms the building block features for each product in the training subset of products to the corresponding mapping coordinates for each product in the training subset of products. The mapping function f is then encoded in a computer readable medium. The mapping function f can be retrieved and used to generate mapping coordinates for any product in the combinatorial library from the building block features associated with the product.

U.S. Pat. No. 6,950,753, to Rzhetsky, Method for Extracting Information on interactions between Biological Entities from Natural-language Genomics Text Data, discloses methods for identifying novel genes comprising: (i) generating one and/or more specialized databases containing information on gene/protein structure, function and/or regulatory interactions; and (ii) searching the specialized databases for homology or for a particular motif and thereby identifying a putative novel gene of interest, The invention may further comprise performing simulation and hypothesis testing to identify or confirm that the putative gene is a novel gene of interest. Rzhetsky also relates to natural language processing and extraction of relational information associated with genes and proteins that are found in genomics journal articles.

U.S. Pat. No. 6,633,819, to Rzhetsky, discloses methods for identifying novel genes comprising: (i) generating one or more specialized databases containing information on gene/protein structure, function and/or regulatory interactions; and (ii) searching the specialized databases for homology or for a particular motif and thereby identifying a putative novel gene of interest. The invention may further comprise performing simulation and hypothesis testing to identify or confirm that the putative gene is a novel gene of interest.

U.S. published patent application 2007/0225956, Causal Analysis in Complex Biological Systems, discloses software assisted systems and methods for analyzing biological data sets to generate hypotheses potentially explanatory of the data. Active causative relationships in the biology of complex living systems are discovered by providing a data base of biological assertions comprising a multiplicity of nodes representative of a network of biological entities, actions, functional activities, and concepts, and relationship links between the nodes. Simulating perturbation of individual root nodes in the network initiates a cascade of virtual activity through the relationship links to discern plural branching paths within the data base. Operational data, e.g., experimental data, representative of a real or hypothetical perturbations of one or more nodes are mapped onto the data base. The branching paths then are prioritized as hypotheses on the basis of how well they predict the operational data. Logic based criteria are applied to the graphs to reject graphs as not likely representative of real biology. The result is a set of remaining graphs comprising branching paths potentially explanatory of the molecular biology implied by the data.

Other U.S. published patent applications disclose related issues, including: US2006/0293873 to Systems and Methods for Reverse Engineering Models of Biological Networks; US 2005/0267721 to Network Models of Biological Complex Systems; and US 2005/0171746 to Network Models of Complex Systems.

### BRIEF SUMMARY OF THE INVENTION

Provided herein is a logic-based ensemble approach to characterize the class of networks that give rise to a given biological function. This logic-based approach, which the present invention applies to a Boolean network model for biomolecular interactions [4], leads to several interesting conclusions about the well-studied cell-cycle function.

In a preferred embodiment, a method and system is provided for obtaining information about a biological network using a logic based approach, comprising the steps of: (a) receiving and storing in a computer memory a list of objects, each object representing a biomolecule within the biological network; (b) assigning each biomolecule two states, on and off; (c) calculating and outputting the space of all possible Boolean networks (W), from the list of biomolecules of a given state; (d) deriving and outputting the number of possible networks that produce a given system function (P) from the space of all possible Boolean networks (W); (e) deriving and outputting all of the minimal networks (M) by calculating the networks with the smallest number of edges from the number of possible networks that produce a system function (P); (f) deriving and outputting the number of networks that are irreducible (I) by calculating those networks in P which upon the removal of any edge would result in a network no longer in (P); and (g) generating output data representing the values of one or more of (W), (P), (M), and (I).

In another preferred embodiment, there is provided wherein the method allows for current satisfiability solvers to be able to solve expressions with millions of variables.

In another preferred embodiment, there is provided computer readable media implementable in a computer system, comprising: program instructions for carrying out the method herein.

A new approach is provided to decomposition that addresses the above large-motif issue in the affirmative. This approach, which is referred to here as process-based analysis, starts by characterizing the space of all possible networks that provide the desired function (process) and then identifies, among these, the minimal networks (with the fewest edges). These minimal networks, it turns out, are few in number and capture the primary functionality—the removal of any single edge from a minimal network destroys the network's function. Thus, such a minimal network forms a giant backbone motif whose edges touch all the nodes and every edge of which is needed to maintain the original network's functionality.

One advantage of identifying possible large backbone motifs becomes clear when examining the remaining edges in the network. For the two examples—cell-cycle models of the budding and fission yeast—the remaining edges form small motifs whose purpose is readily apparent. These small motifs do not provide the network's main function but instead confer stability properties: they either make the network more robust to perturbation (more states lead to the main attraction) or strengthen the dynamics (more states lead to the main trajectory).

The approach and conclusions rely on the Boolean model, which abstracts away molecular concentrations into two molecular states “on” (active) or “off” (inactive) and in which interactions are modeled as either stimulatory or inhibitory. Such assumptions are standard in the Boolean model [23, 24, 2], which is often used in place of models based on differential equations to simplify modeling and to elicit higher-level network properties and which lends itself, in our approach, to logic-based analysis.

These general limitations notwithstanding, the present approach provides several benefits. First, as a natural consequence of the logic-based technique, the collection of all possible networks that produce a given behavior is characterized by a single equation that directly reveals useful structure: for example, edges that are necessary for function are identified by algebraically factoring the equation. Second, the equation can be analyzed to enumerate all minimal networks (possible backbone motifs), as described here. These turn out to be small enough in number to identify which one is actually present in the given network. Third, the existence of a solution to the equation can be solved very efficiently (in polynomial time), which suggests that the technique will scale efficiently to larger numbers of nodes. Finally, and importantly, the equation allows one to quickly categorize edges into three useful types: edges that are rigid (the edges common to all minimal networks), edges that are interchangeable (these edges can be substituted by alternatives but are essential for the process) and supplemental (these are not essential to function but confer stability properties).

The above categorization of edges is independently useful because it allows one to immediately identify edges that contribute to function, and those that contribute to stability. For the budding yeast network, this leads to an additional insight about how small motifs help control the separation of cell cycle phases. The technique described herein also can be applied to cases where the underlying network is completely unknown, in which case what is useful to the biologist from the analysis is the structure of the minimal network.

### BRIEF DESCRIPTION OF THE DRAWINGS

FIG. 1 shows, for budding yeast: (a) the time course (a sequence of known states that is obtained from experimental data and that is the input to the technique described here) of the 11 nodes as a representation of the cell cycle process; (b) the full cell cycle network; (c) the backbone sub-network contained in the full network; (d) the supplemental edges are characterized by various feedback loops (r₉₈ and r_{7,10} are shown as dashed line because they are shared with the backbone);

FIG. 2 shows, for fission yeast: (a) the time course of the 9 nodes as a representation of the cell cycle process; (b) the full cell cycle network; (c) the backbone sub-network contained in the full network; (d) the remaining edges are characterized by mutual inhibitive loops (the r₃₂ is shown as dashed line because it is shared with the backbone);

FIG. 3 shows a phase transition portrait of the budding yeast network, where the 1875 network states in the basin of the attractor A* are shown as red dots; the main dynamical trajectory, colored in blue, corresponds to the normal cell cycle process; the other 173 states (not shown) converge into six other attractors;

FIG. 4 shows the B and W values of perturbed networks derived from the budding yeast and fission yeast networks, where group-I, -II, and -III networks are represented by red, green, and blue dots respectively; the big black point and the big purple point represent the full network and the minimal network, respectively. FIG. 4(a) shows the B-W diagram for budding yeast, and FIG. 4(b) shows the B-W diagram for fission yeast;

FIG. 5 shows the change of trajectories caused by mutual inhibition. The middle, blue trajectory represents the budding yeast cell cycle process S*. States with (s₉ s₁₀))=(1 1) are shown as black dots, including 16 initial states which are smaller. (a) In the minimal network, the states follow harmful trajectories to converge to the attractor. There are three successive durations of (s₉ s₁₀)=(1 1). (b) In the full network, the 16 initial states immediately converge to the normal cell cycle process. (c) The actual states represented by the black dots; and,

FIG. 6 is a flow chart of reverse engineering and network decomposition, where FIG. 6(a) shows the general procedure and FIG. 6(b) shows an example of budding yeast network.

### DETAILED DESCRIPTION OF THE INVENTION

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

### The Boolean Network Model

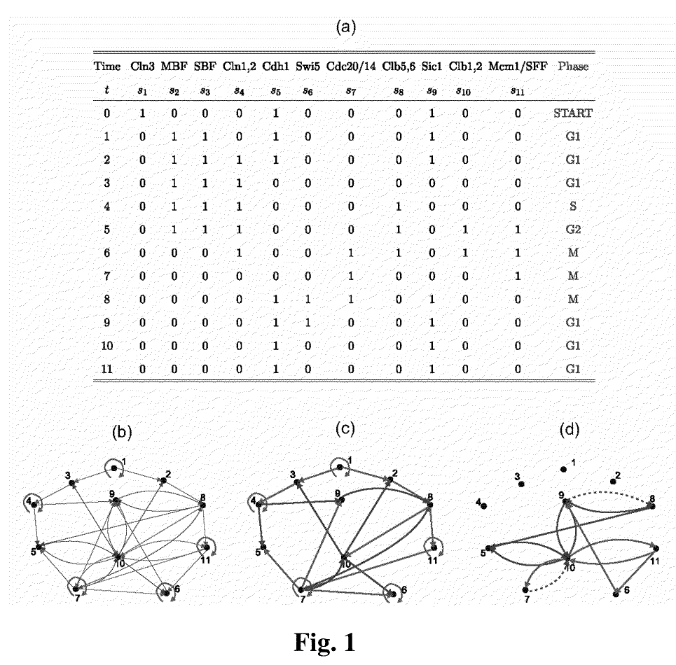

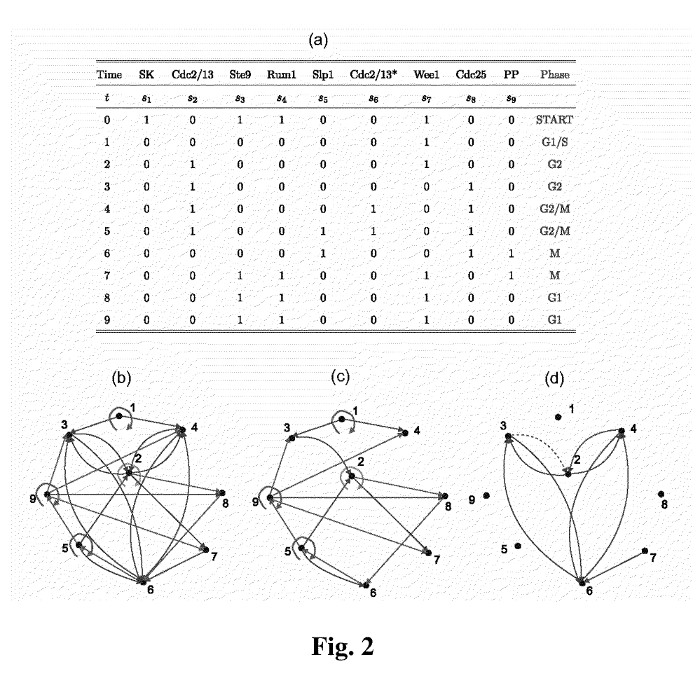

The starting point for our model is a collection of N kinds of interacting molecules, each of which at any given time is modeled as either “on” (active, or highly expressed) or “off” (inactive). Then, at any given time, the system of N molecules is in a system- or network-state and over time, the system dynamically changes from state to state depending on the interactions between the molecules. Thus, from a given start state, there is a well-defined sequence of system states that end up in a stable system state often called an attractor. This sequence or trajectory of such system states a Boolean process, examples of which are shown in FIGS. 1(a) and 2(a) for the budding yeast and fission yeast cell-cycles, respectively. Particularly, FIG. 1(a) shows the time course (a sequence of known states that is obtained from experimental data and that is the input to the technique described here) of the 11 nodes as a representation of the cell cycle process of budding yeast, and FIG. 2(a) shows the time course of the 9 nodes as a representation of the cell cycle process of fission yeast. Given the initial cell cycle state, the outcome of the network is a well-defined trajectory of states that correspond to different phases of the cell cycle. Such a trajectory can thus be considered the function of the cell-cycle network. More formally, let sᵢ(t)ε{0,1} denote the state of molecule i and S(t)=(sₗ(t), . . . , s_{N}(t)) the state of the system at time t. Here, time is assumed to be discrete: t=0, 1, 2, . . . and thus a molecule possibly changes state in a time step. A sequence of such systems states, S*=S(0), S(1), . . . , S(T−1) is what is generally referred to here as a Boolean process. Intuitively, in biological terms, a Boolean process corresponds to discretized time-course data. Thus, a sequence of microarray snapshots taken for a system of molecules taken over a time course can be converted into this Boolean form by noting which molecules are active and which are not.

The dynamics of a Boolean network (BN) model (determining the next state from the current state) can be described as follows [4]:

$${s}_{i} ( t + 1 ) = \{ \begin{matrix}1 & {\sum }_{j} {a}_{ji} {s}_{j} > 0 \\ 0 & {\sum }_{j} {a}_{ji} {s}_{j} < 0 \\ {s}_{i} ( t ) & {\sum }_{j} {a}_{ji} {s}_{j} = 0\end{matrix} \qquad [ 1 ]$$

where (aⱼᵢ) is a N×N matrix encoding the network structure. The diagonal entries, aᵢᵢ, take the value −1 (self degradation), 1 (self activation), or 0 (no action). The non-diagonal entries, aⱼᵢ, (j≠i), take the value −γ 1, or 0, depending on whether node j inhibits, activates, or does not interact with, node i.

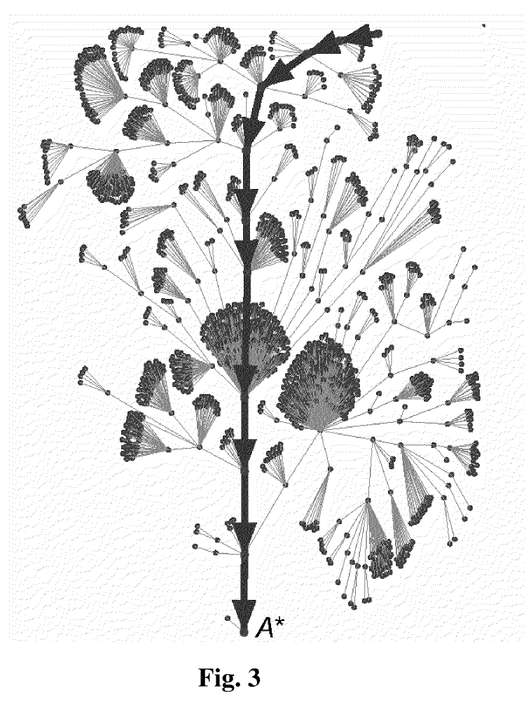

The parameter γ models the relative dominance of inhibition over stimulation. Since inhibition is dominant over stimulation for most biomolecular interactions, one prefers γ≧1. Moreover, the network dynamics is usually not sensitive to the value of γ (the network topology is more important than the actual interaction strength). For the budding yeast network, the cases γ=3, 4, 5, . . . , produce exactly the same dynamics and are only slightly different from the cases γ=1, 2. For the fission yeast network, the cases γ=2, 3, 4, . . . , ∞ produce exactly the same dynamics and are only slightly different from the cases γ=1. The invention therefore follows the “dominant inhibition” assumption [7, 8, 9] by setting γ=∞. This assumption renders a simpler, logical representation of Eq. (1), namely:

$${s}_{i} ( t + 1 ) = ( {\sum }_{j \neq i} ( {s}_{j} ( t ) {g}_{ji} ) + {s}_{i} ( t ) {\overline{r}}_{ii} + \overline{{s}_{i} ( t )} {g}_{ii} ) {\prod }_{j \neq i} ( \overline{{s}_{j} ( t ) {r}_{ji}} ) , \qquad [ 2 ]$$

where rⱼᵢ represents a putative inhibitory (red) edge from node j to node i, gⱼᵢ represents a putative stimulatory (green) edge from node j to node i, addition represents the Boolean operator OR, and multiplication represents AND; the bar on a variable represents NOT. The figures differentiate stimulatory and inhibitory edges with color, but the color is irrelevant to the logic-based analysis. In the figures, green is the lightest shade, red is darker, and blue (FIGS. 3-5) is the darkest shade.

### Satisfiability of the Network Equation

Since, in principle, each pair of nodes might have a green or red edge between them, the number of variables is of the order of N². For the 11-node cell-cycle example, it is possible to write down the equation by hand and simplify the equation sufficiently to find solutions. However, it is now shown how the solution can be automated by an algorithm which exploits the fact that the equations (2) are node-wise independent (because they do not share any variables). Next, let l(t)=: sⱼ(t)=1) the states which are “on” at time t. The steps in the algorithm are:

| | |
|---|---|
| 1. | // Identify those edges that cannot be red |
| | // because they would interfere with a 0 → 1 |
| | // or 1 → 1 transition: |
| | CannotBeRed = Ø |
| | NoEdge = Ø |
| | for all t such that sᵢ(t) = 1 |

for all j ∈ I(t − 1)

CannotBeRed ← CannotBeRed ∪{j}

| | |
|---|---|
| 2. | // Identify those cases where self-degradation |
| | // is necessary. |
| | for all t such that sᵢ(t − 1) = 1,sᵢ(t) = 0 |

if I(t − 1) [symbol] CannotBeRed

SelfDegradation ← true
NoEdge ← NoEdge ∪I(t − 1)

| | |
|---|---|
| 3. | // Now assign red edges |
| | for all j ∈ I(t − 1) - CannotBeRed - NoEdge |

rⱼᵢ ← 1

| | |
|---|---|
| 4. | // Next, identity edges that cannot be green. |
| | for all t such that sᵢ(t − 1) = 0,sᵢ(t) = 0 |

if I(t − 1) has no red edges

// None of them can be green,
// else sᵢ(t) would be 1.
CannotBeGreen ← CannotBeGreen ∪ I(t − 1)

for all t such that sᵢ(t − 1) = 1,sᵢ(t) = 0

if I(t − 1) has no red edges

and not SelfDegradation=true

// None of them can be green,
// else sᵢ(t) would be 1.
CannotBeGreen ← CannotBeGreen ∪ I(t − 1)

| | |
|---|---|
| 5. | // Assign the remaining to green. |
| | for all j ∈ CannotBeRed - NoEdge - CannotBeGreen |

gⱼᵢ ← 1

Finally, note that once the edges have been identified, the network is “run” on the process to see if it is consistent with the process. If not, no solution exists. The above algorithm identifies whether a solution exists in polynomial time (O(MN²)).

### Solving the Network Equation

Since the state variables S(t) are known from the biological process, Eq. (2), for t=0, 1, . . . , T−1, are used to infer the network connections to node i. As illustrated by the example in the Supporting Information section, the equations can be simplified because many variables are already factored out. The simplified equations are then solved by the above algorithm.

The number of solution networks is called the designability of the process [6]; the idea is that, a process with many network solutions is likely to be more favored in nature because it would be easier for an evolutionary process to create. Li et al [6] estimate the designability (for very small networks) using time-consuming exhaustive enumeration, while our approach can compute the designability directly from the equation. For example, the budding yeast process has a designability of 2.84×10³¹, whereas the fission yeast process has a designability of 9.61×10²¹.

### Minimal Networks and Edge Classification

One issue is what the smallest network would be that solves the equation. Such a minimal network serves as the “backbone” motif discussed earlier. Again, all such minimal networks are enumerated to identify which minimal network (backbone) is present in a given network (see Supporting Information). For example, there are 108,864 minimal networks that arise from analyzing the budding yeast process of FIG. 1(b), among which one and only one is contained in the budding yeast network.

### Network Dynamical Properties

To study the dynamical properties of putative networks, the invention uses two measures of robustness. Both are based on constructing the state-transition graph or attractor-basin portrait, an example of which (for the budding yeast) is shown in FIG. 3. FIG. 3 shows a phase transition portrait of the budding yeast network, where the 1875 network states in the basin of the attractor A* are shown as red dots. The figure also shows the sequence of states corresponding to the normal cell cycle process, the main trajectory (or process) through the transition graph. The main dynamical trajectory is colored in blue in FIG. 3. The first and most commonly used measure is the basin size B: the number of states that converge to the main attractor. A large basin is considered an indication of stability [4], because a perturbation in state results in a convergent path to the main attractor. The other 173 states (not shown) converge into six other attractors.

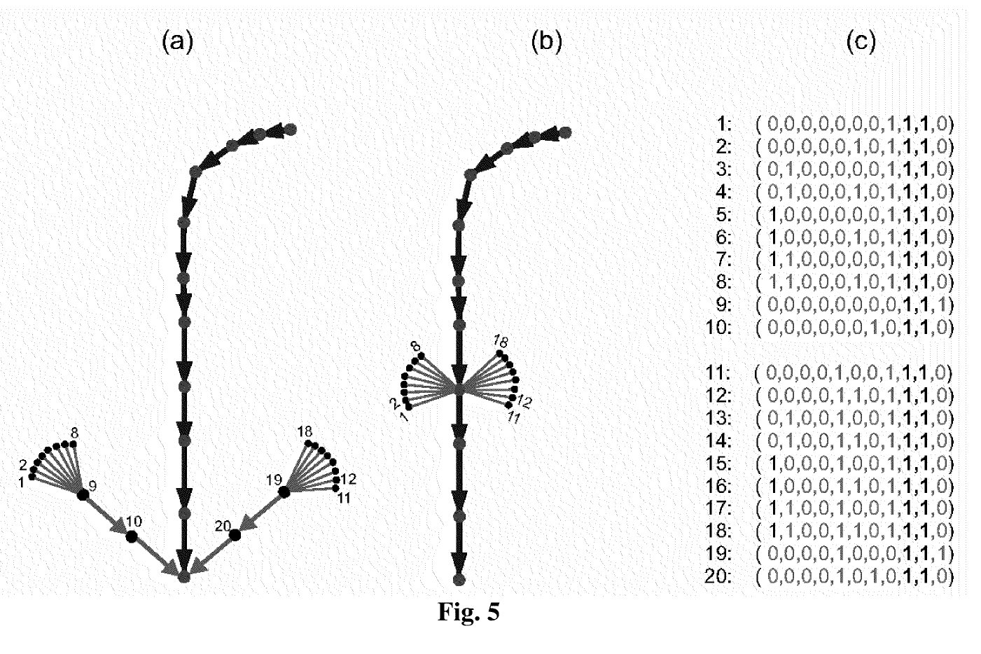

A more refined measure of robustness is suggested in [4], based on observing that it is not sufficient to require a perturbed state to converge to the attractor, but rather, to require a perturbed state to return to the main trajectory. One way to quantify this idea is to compute the trajectory overlap W using the trajectory of states from every single state to its attractor. FIG. 5(a) illustrates that in the minimal network, the states follow harmful trajectories to converge to the attractor. There are three successive durations of (s₉ s₁₀=)=(1 1). FIG. 5(b) illustrates that in the full network, the 16 initial states immediately converge to the normal cell cycle process. In FIG. 5(b), for example, there is a larger trajectory overlap than in FIG. 5(a), which correlates with the fact that most states go through the main process. In [4], a quantity wₙ(n=1, 2, . . . , 2^{N}) was defined for each of the 2^{N} network states that measures the overlap of its trajectory with all other trajectories. The overlap of all trajectories was defined to be W=(wₙ), where the average was over all network states [4]. Note that, our focus is the main attractor A*, hence, W=(wₙ), where the average is over the basin of A*.

These measures tell us that high values of B and W are desirable—an indication that there is a single strong trajectory to the main attractor and that perturbations almost always lead back to this trajectory. Below, it is examined how the edge classification relates to these measures.

### Model Systems Studied

The methods are applied to the cell-cycle networks of the budding yeast (S. cerevisiae) and fission yeast (S. pombe) cells. The Boolean model for the budding yeast cell-cycle is from [4] and is shown in FIG. 1(b). The network has N=11 nodes and 34 edges. The cell-cycle process is represented by the sequence of states depicted in FIG. 1(a), the last of which is the main attractor A* with a large basin size 1875 (91.6% of the total 2^{N}=2048 states).

The Boolean network for fission yeast is from [25], which has N=9 nodes and 26 edges (FIG. 2(b)). The biological process is shown in FIG. 2(a). Here, the main attractor here has a basin size of 416, about 81.3% of the total 2^{N}=512 states.

### Results of the Invention

### The Backbone Motif and Smaller Motifs

Eq. (2) is applied to the budding and fission processes of FIGS. 1(a) and 2(a) respectively, which obtains the following results:
Budding yeast. The equation for the budding yeast yielded 108,864 minimal networks, each with 23 edges, one (and only one) of which is a complete subset of the full network in FIG. 1(b). This minimal network, the backbone motif, is shown in FIG. 1(c). Upon analyzing the remaining 11 edges, shown in FIG. 1(d), the invention finds a negative feedback loop (g_{10,7} r_{7,10}), a positive feedback loop (g_{10,11} g_{11,10}), and three mutual-inhibition loops (r_{5,10} r_{10,5}) (r_{9,10} r_{10,9}) and (r_{8,9} r_{9,8}).
Fission yeast. For the fission yeast, the equation yielded 1024 minimal networks, each with 18 edges, one (and only one) of which is the backbone shown in FIG. 2(c). Analysis of the remaining edges shown in FIG. 2(d) reveals four mutually-inhibitory loops.

Thus, in both cases, the approach has identified for each network a spanning sub-network (the backbone motif) and several smaller motifs. Identification of the smaller motifs was made possible when the backbone edges were removed from the network.

Thus far it has been shown how to identify the backbone and the smaller motifs. Next will be described the evidence that the backbone network carries out the main function while the smaller motifs confer stability properties.

### Edge Classification and Robustness

To see why the backbone motif is crucial to function, return to the edge classification described earlier: rigid edges are edges that must be present in all minimal networks, supplemental edges are those whose values do not contribute to the solution of Eq. (2), and interchangeable edges are the remaining (these are how the minimal networks differ). Any minimal network consists of all the rigid edges and some interchangeable edges and, thus, one would like to determine the contribution of these edges to the network's function.

To examine the contribution of any group of edges, remove the edges from the cell-cycle network and compute the robustness measures B and W for the resulting network. Three types of networks are defined that result from selective deletion of edges: In Group-I, some combination of rigid edges are removed. Similarly, Group-II networks consist of the networks one gets when removing a random subset of interchangeable edges. Likewise, Group-III networks result from removing some combination of supplemental edges.

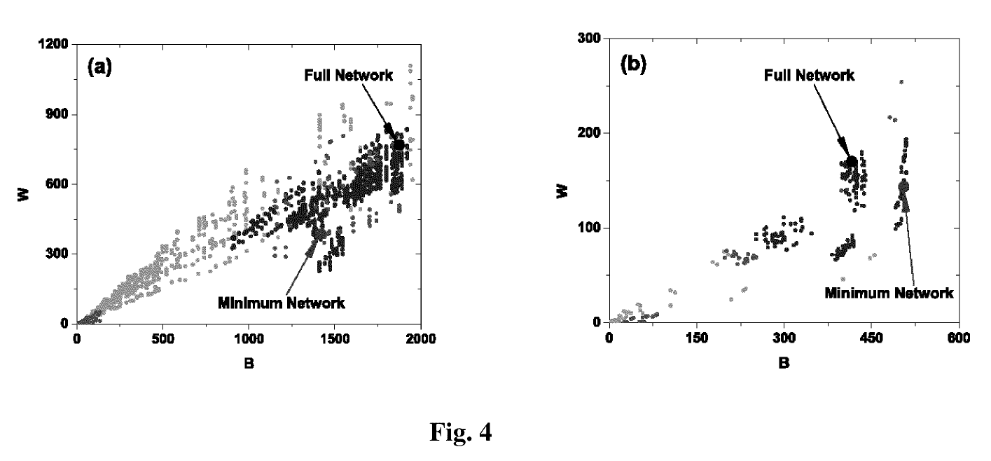

It is expected that the Group-II and III networks would be less robust than the original network, while Group-I networks should experience an almost total loss of function. This is indeed the case, as shown by plotting B vs. W in FIGS. 4(a) and (b) for budding and fission yeast respectively. FIG. 4 shows the B and W values of perturbed networks derived from the budding yeast and fission yeast networks, where group-I, -II, and -III networks are represented by red, green, and blue dots respectively; the big black point and the big purple point represent the full network and the minimal network, respectively.
Rigid edges. Removing any rigid edge results in a loss of function because, by definition, any network that satisfies the given process must contain these edges. However, one may still ask whether the resulting (Group-I) networks, even if they lack function, still have robustness properties. The red dots in FIGS. 4(a) and (b) represent these perturbed networks. Interestingly, they fall into two categories. The red dots on the left are those with severely impaired function and virtually no robustness, as one would expect from removing backbone edges. However, the red dots on the right (higher robustness), while non-functional still display some robustness, something that requires explanation. A careful analysis of the edges involved in the right cluster reveals edges that play a role in the early steps of the process. Thus, their removal still leaves the latter part of the process intact, with some degree of robustness.
Supplemental edges. Consider the budding yeast network of FIG. 1(b) and the 11 supplemental edges shown in FIG. 1(d). These 11 supplemental edges, when removed in all possible combinations, result in 2¹¹=2048 perturbed networks, each of which will have a B and W value. These 2048 points are plotted as blue dots in FIG. 4(a). Clearly, the blue dots spread towards lower B and W values, indicating loss of robustness. FIG. 4(b) confirms the same result for the fission yeast.
Interchangeable edges. To complete the robustness analysis, the effects of removing interchangeable edges are examined. Recall that these edges are needed in minimal networks but there is some choice in using them—every minimal network has some (but not all) of them. For the budding yeast, there are 13 such interchangeable edges and thus 2¹³=8192 perturbed networks can be created by removing a subset of them, shown by the green dots in FIG. 4(a). Similarly, the green dots in FIG. 4(b) represent perturbed networks for the fission yeast. Removal of some of these edges results in both loss of robustness as well as loss of function; in this case, the loss of robustness is more severe.

FIG. 4 also shows two special networks. The black dot indicates the (B, W) value for the original network, while the purple dot indicates the (B, W) value for the minimal network.

### Small Motifs and Phase Regulation

Some of the small motifs exposed by the analyses of the two cell-cycle networks are now examined. Together, they reveal a number of valuable insights related to regulating the phases of the cell cycle. The first is that many of the motifs involve nodes (5, 8, 9, 10 in budding yeast [12, 13, 14, 15, 16], and 2, 3, 4, 6 in fission [26, 27, 28, 29, 30]), which are master regulators.

This is not surprising, but a confirmation that the type of analysis presented here correlates with what is known by biologists. What one would like to know is whether motifs that involve these molecules explain the phase-regulation role.

Consider the budding yeast motif with edges r_{9,10} r_{10,9}. These edges prevent the simultaneous occurrence of s₉=1 and s₁₀=1, a state that might be considered as a harmful overlap of the Gl and M phases. To further analyze, it is considered what happens when this motif is removed. FIG. 5 shows the change of trajectories caused by mutual inhibition. The middle, blue trajectory represents the budding yeast cell cycle process S*. FIG. 5(a) shows the relevant portion of the state-transition diagram (the attractor-basin portrait), with the process shown in blue and the (harmful) states with (s₉,s₁₀)=(1,1) shown as black dots. The minimal network (without the regulatory motif) shows these states converging independently and directly to the attractor, whereas when the motif is added to the minimal network we get the behavior in FIG. 5(b)—here, there are two observations to be made. The first is that harmful states are quickly invalidated: each harmful combination state lasts only one step when the motif is used. The second, equally important but different observation is that the motif directs the harmful states directly to the cell cycle process (whereas in the motif-free network, the harmful states last longer and follow an independent path to the attractor, bypassing the main process). Thus, it is as if the motif provides a checkpoint to ensure that the process of cell phases is carried out both fully and separately. For reference, FIG. 5(c) shows the process for each case and how the small motif, as a tiny addition to network, makes all the difference to stability.

### Support Information

Flow chart of network decomposition procedure: For a given biological network, its dynamics or the state transition graph will be generated using Eq. (2) to solve for the state variables sᵢ(t) with the known interaction variables rᵢⱼ and gⱼᵢ. The convergent trajectory S* of the dynamics is extracted, which, as first argued by Li et al[3], represents the primary biological process or function of the given biological network. Eq. (2) is employed again but to solve for now unknown interaction variables rⱼᵢ and gⱼᵢ to identify all feasible network solutions that support the biological process S* but not necessarily the entire dynamics. Note that the state variables sᵢ(t) are now known and restricted to S*.

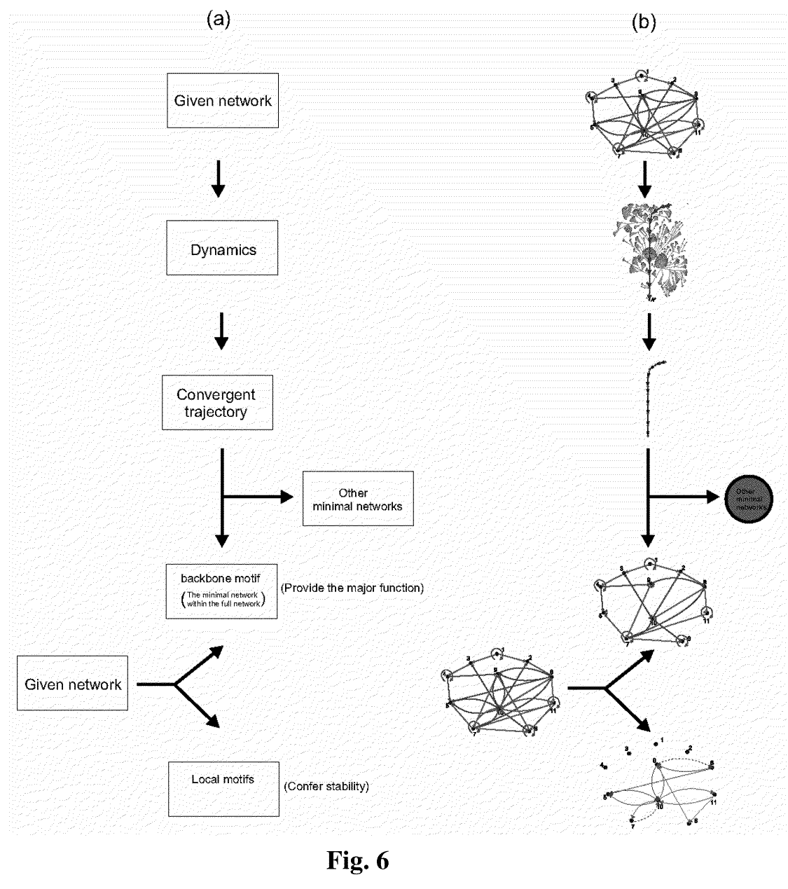

There are a large number of network solutions besides the original network, among which is the minimal network of smallest number of interactions that is also a subnetwork of the given network. This particular minimal network thus forms the backbone of the network decomposition that is mandatory to maintain the primary function without any redundant interactions. Interestingly, by dissecting the backbone from the given network, the remaining edges clearly show recurring motif patterns in the forms of mutual inhibition or activation loops. Furthermore, the role that these small motifs might play can be clearly characterized and was found to enhance the stability of the primary functions as described in the main text. FIG. 6 is a flow chart of reverse engineering and network decomposition, which illustrates the key components of the flow chart of a generic network decomposition procedure with the particular example of budding yeast cell cycle network. Particularly, FIG. 6(a) shows the general procedure and FIG. 6(b) shows an example of budding yeast network.

An example of solving the network equation: We use node i=6 of the budding yeast network as an example to explain the Boolean equations and their solution. The following Table 1 is a reproduction of FIG. 1(a), where the states of node 6 are highlighted in red.

TABLE 1

| Time | Cln3 | MBF | SBF | Cln1, 2 | Cdh1 | Swi5 | Cdc20/14 | Clb5, 6 | Sic1 | Clb1, 2 | Mcm1/SFF | |
|---|---|---|---|---|---|---|---|---|---|---|---|---|
| t | s₁ | s₂ | s₃ | s₄ | s₅ | s₆ | s₇ | s₈ | s₉ | s₁₀ | s₁₁ | Phase |
| 0 | 1 | 0 | 0 | 0 | 1 | 0 | 0 | 0 | 1 | 0 | 0 | START |
| 1 | 0 | 1 | 1 | 0 | 1 | 0 | 0 | 0 | 1 | 0 | 0 | G1 |
| 2 | 0 | 1 | 1 | 1 | 1 | 0 | 0 | 0 | 1 | 0 | 0 | G1 |
| 3 | 0 | 1 | 1 | 1 | 0 | 0 | 0 | 0 | 0 | 0 | 0 | G1 |
| 4 | 0 | 1 | 1 | 1 | 0 | 0 | 0 | 1 | 0 | 0 | 0 | S |
| 5 | 0 | 1 | 1 | 1 | 0 | 0 | 0 | 1 | 0 | 1 | 1 | G2 |
| 6 | 0 | 0 | 0 | 1 | 0 | 0 | 1 | 1 | 0 | 1 | 1 | M |
| 7 | 0 | 0 | 0 | 0 | 0 | 0 | 1 | 0 | 0 | 0 | 1 | M |
| 8 | 0 | 0 | 0 | 0 | 1 | 1 | 1 | 0 | 1 | 0 | 0 | M |
| 9 | 0 | 0 | 0 | 0 | 1 | 1 | 0 | 0 | 1 | 0 | 0 | G1 |
| 10 | 0 | 0 | 0 | 0 | 1 | 0 | 0 | 0 | 1 | 0 | 0 | G1 |
| 11 | 0 | 0 | 0 | 0 | 1 | 0 | 0 | 0 | 1 | 0 | 0 | G1 |

For each state transition, an equation according to Eq. (2) can be written. The equations are:

$$\begin{matrix}\begin{matrix}0 \\ ↓\end{matrix} {r}_{1 i} + {r}_{5 i} + {r}_{gi} + {\overline{g}}_{ii} {\overline{g}}_{1 i} {\overline{g}}_{5 i} {\overline{g}}_{9 i} = 1 & [ S .1 ] \\ \begin{matrix}0 \\ ↓\end{matrix} {r}_{2 i} + {r}_{3 i} + {r}_{5 i} + {r}_{9 i} + {\overline{g}}_{ii} {\overline{g}}_{2 i} {\overline{g}}_{3 i} {\overline{g}}_{5 i} {\overline{g}}_{9 i} = 1 & [ S .2 ] \\ \begin{matrix}0 \\ ↓\end{matrix} {r}_{2 i} + {r}_{3 i} + {r}_{4 i} + {r}_{5 i} + {r}_{9 i} + {\overline{g}}_{ii} {\overline{g}}_{2 i} {\overline{g}}_{3 i} {\overline{g}}_{4 i} {\overline{g}}_{5 i} {\overline{g}}_{9 i} = 1 & [ S .3 ] \\ \begin{matrix}0 \\ ↓\end{matrix} {r}_{2 i} + {r}_{3 i} + {r}_{4 i} + {\overline{g}}_{ii} {\overline{g}}_{2 i} {\overline{g}}_{3 i} {\overline{g}}_{4 i} = 1 & [ S .4 ] \\ \begin{matrix}0 \\ ↓\end{matrix} {r}_{2 i} + {r}_{3 i} + {r}_{4 i} + {r}_{8 i} + {\overline{g}}_{ii} {\overline{g}}_{2 i} {\overline{g}}_{3 i} {\overline{g}}_{4 i} {\overline{g}}_{8 i} = 1 & [ S .5 ] \\ \begin{matrix}0 \\ ↓\end{matrix} {r}_{2 i} + {r}_{3 i} + {r}_{4 i} + {r}_{8 i} + {r}_{10 , i} + {r}_{11 , i} + {\overline{g}}_{ii} {\overline{g}}_{2 i} {\overline{g}}_{3 i} {\overline{g}}_{4 i} {\overline{g}}_{8 i} {\overline{g}}_{10 , i} {\overline{g}}_{11 , i} = 1 & [ S .6 ] \\ \begin{matrix}0 \\ ↓\end{matrix} {r}_{4 i} + {r}_{7 i} + {r}_{8 i} + {r}_{10 , i} + {r}_{11 , i} + {\overline{g}}_{ii} {\overline{g}}_{4 i} {\overline{g}}_{7 i} {\overline{g}}_{8 i} {\overline{g}}_{10 , i} {\overline{g}}_{11 , i} = 1 & [ S .7 ] \\ \begin{matrix}0 \\ ↓\end{matrix} {\overline{r}}_{7 i} {\overline{r}}_{11 , i} ( {g}_{ii} + {g}_{7 i} + {g}_{11 , i} ) = 1 & [ S .8 ] \\ \begin{matrix}1 \\ ↓\end{matrix} {\overline{r}}_{5 i} {\overline{r}}_{7 i} {\overline{r}}_{9 i} ( {\overline{r}}_{ii} + {g}_{5 i} + {g}_{7 i} + {g}_{9 i} ) = 1 & [ S .9 ] \\ \begin{matrix}1 \\ ↓\end{matrix} {r}_{5 i} + {r}_{9 i} + {r}_{ii} {\overline{g}}_{5 i} {\overline{g}}_{9 i} = 1 & [ S .10 ] \\ \begin{matrix}0 \\ ↓ \\ 0\end{matrix} {r}_{5 i} + {r}_{9 i} + {\overline{g}}_{ii} {\overline{g}}_{5 i} {\overline{g}}_{9 i} = 1 & [ S .11 ]\end{matrix}$$

From Eqs. (S.8) and (S.9), one obtains r₅ᵢ=r₇ᵢ=r₉ᵢ=r_{11,i}=0. After substituting them into the above equations, one obtains:

r₁ᵢ+ g̅ᵢᵢ g̅₁ᵢ g̅₅ᵢg₉ᵢ=1 [S.12]

r₂ᵢ+r₃ᵢ+ g̅ᵢᵢ g̅₂ᵢ g̅₃ᵢ g̅₅ᵢg₉ᵢ=1 [S.13]

r₂ᵢ+r₃ᵢr₄ᵢ g̅ᵢᵢ g̅₂ᵢ g̅₃ᵢ g̅₄ᵢ g̅₅ᵢ g̅₉ᵢ=1 [S.14]

r₂ᵢ+r₃ᵢr₄ᵢ+ g̅ᵢᵢ g̅₂ᵢ g̅₃ᵢ g̅₄ᵢ=1 [S.15]

r₂ᵢ+r₃ᵢr₄ᵢ+r₈ᵢ+ g̅ᵢᵢ g̅₂ᵢ g̅₃ᵢ g̅₄ᵢ g̅₈ᵢ=1 [S.16]

r₂ᵢr₃ᵢr₄ᵢ+r₈ᵢ+r_{10,i}+ g̅ᵢᵢ g̅₂ᵢ g̅₃ᵢ g̅₄ᵢ g̅₈ᵢ g̅_{10,i} g̅_{11,i}=1 [S.17]

r₄ᵢ+r₈ᵢ+r_{10,i}+ g̅ᵢᵢ g̅₄ᵢ g̅₇ᵢ g̅₈ᵢ g̅_{10,i} g̅_{11,i}=1 [S.18]

gᵢᵢ+g₇ᵢ+g_{11,i}=1 [S.19]

r̅ᵢᵢ+g₅ᵢ+g₇ᵢ+g_{gi}=1 [S.20]

rᵢᵢ g̅₅ᵢ g̅₉ᵢ=1 [S.21]

g̅ᵢᵢ g̅₅ᵢ g̅₉ᵢ=1 [S.22]

From Eqs. (S.21) and (S.22), one obtains rᵢᵢ=1 and g_{5,i}=g₉ᵢ=0, which yields g_{7,i}=1 and g₁ᵢ=0 after their substitution into Eq. (S.20) and (S.12), respectively. The above equations are further simplified into:

r₂ᵢ+r₃ᵢ+g₂ᵢg₃ᵢ=1

r₂ᵢ+r₃ᵢ+r₄ᵢ+g₂ᵢg₃ᵢg₄ᵢ=1

r₂ᵢr₃ᵢr₄ᵢr₈ᵢ+g₂ᵢg₃ᵢg₄ᵢg₈ᵢ=1

r₄ᵢ+r₈ᵢ+r_{10,i}=1

To solve the above equations, one needs only to enumerate nodes 2, 3, 4, 8, and 10. We first enumerate node 2, which has three possibilities: r₂ᵢ=1 (red edge), g₂ᵢ=1 (green edge), or n₂ᵢ=1 (no edge). Note the new variable nⱼᵢ we have used; it satisfies the relational equations nⱼᵢ=\vec{r}ⱼᵢ\vec{g}ⱼᵢ, g̅ⱼᵢ=rⱼᵢ+nⱼᵢ, etc. The substitution of r₂ᵢ=1 yields:

r₄ᵢ+r₈ᵢ+r_{10,i}=1,

The substitution of g₂ᵢ=1 yields

r₃ᵢ=1

r₃ᵢ+r₄ᵢ=1

r₃ᵢ+r₄ᵢ+r₈ᵢ=1.

r₄ᵢ+r₈ᵢ+r_{10,i}=1.

The substitution of n₂ᵢ=1 yields

r₃ᵢ+g₄ᵢ=1

r₃ᵢ+r₄ᵢ+r₈ᵢ+ g̅₄ᵢ g̅_{gi}=1

r₄ᵢr₈ᵢ+r_{10,i}=1.

As can be seen from above, the equations are greatly simplified after each substitution. The invention then successively enumerate other nodes, until the solutions become apparent. In total there are 432 solutions, which is the designability of node 6. The following lists four exemplary solutions:

n₁ᵢn₂ᵢn₃ᵢn₅ᵢrᵢᵢg₇ᵢn₈ᵢn₉ᵢn_{10,i}n_{11,i}=1, [S.23]

n₁ᵢn₂ᵢn₃ᵢn₄ᵢn₅ᵢrᵢᵢg₇ᵢn₉ᵢn_{10,i}n_{11,i}=1, [S.24]

n₁ᵢn₂ᵢn₃ᵢn₄ᵢn₅ᵢrᵢᵢg₇ᵢn₈ᵢn₉ᵢn_{11,i}=1, [S.25]

and

r₁ᵢr₂ᵢg₃ᵢn₅ᵢrᵢᵢg₇ᵢr₉ᵢn_{10,i}g_{11,i}=1. [S.26]

Edge classification: The edges can be classified according to their importance in the solutions. The rigid edges are those absolutely required edges. For node i=6, they are r_{d} and g₇ᵢ, which are shown in red in Eqs. (S.23-S.26). The interchangeable edges are those edges that can be replaced by each other. For node i=6, only one of the three edges r₄ᵢ, r₈ᵢ, and r_{10,i} is required. They are thus interchangeable edges, shown in green in Eqs. (S.23-S.26). The supplemental edges are not mandatory for the biological process. They are removable. They are shown in blue in Eq. (S.26). All the rigid edges and one set of interchangeable edges constitute a minimal solution. For node i=6, Eqs. (S.23-S.25) are the minimal solutions, while Eq. (S.26), which consists of a lot of supplemental edges, is not.

Minimal networks: Table 2 below summarizes the minimal solutions (rigid and interchangeable edges) of all the nodes of the budding yeast network. The rigid and interchangeable edges of all the nodes of the budding yeast network. The starred edges are known to have naturally occurred in the cell cycle of budding yeast. A minimal network can be constructed by selecting one minimal solution from every node. There are in total 108,864 minimal networks.

TABLE 2

| Node | Rigid | Interchangeable |
|---|---|---|
| 1 | — | (r₁₁)*, (r₅₁), (r₉₁) |
| 2 | (g₁₂)* | (r_{10,2})*, (r_{11,2}) |
| 3 | (g₁₃)* | (r_{10,3})*, (r_{11,3}) |
| 4 | — | (g₃₄ r₄₄)*, (g₂₄ r₄₄), (g₂₄ r₇₄), (g₃₄ r₇₄) |
| 5 | (r₄₅)* | (g₅₅), (g₇₅)*, (g_{11,5}) |
| 6 | (r₆₆ g₇₆)* | (r_{10,6})*, (r₄₆), (r₈₆) |
| 7 | — | (r₇₇ g_{11,7})*, (r₅₇ g_{10,7}), (r₅₇ g_{11,7}), (r₆₇ |
| | | g_{11,7}), (r₆₇ g_{10,7}), (r₉₇ g_{10,7}), (r₉₇ g_{11,7}) |
| 8 | — | (g₂₈ r₇₈ r₉₈)*, (g₈₈ r₅₈ r₇₈), (g₈₈ r₇₈ r₉₈) |
| | | (g₂₈ r₅₈ r₇₈), (g₂₈ r₅₈ r₈₈), (g₂₈ r₈₈ r₉₈), |
| | | (g₃₈ r₅₈ r₇₈), (g₃₈ r₅₈ r₈₈), (g₃₈ r₇₈ r₉₈), |
| | | (g₃₈ r₈₈ r₉₈), (g₄₈ r₅₈ r₇₈), (g₄₈ r₇₈ r₉₈) |
| 9 | (r₄₉)* | (g₉₉), (g₇₉)*, (g_{11,9}) |
| 10 | (r_{7,10} g_{8,10})* | — |
| 11 | (g_{8,11} r_{11,11})* | — |

### Computer Implementation Systems and Methods

The methods described above may advantageously be implemented using a computer-based approach, and the present invention therefore includes a computer system for practicing the methods. The system can also be operated on a microarray machine, used by biologists, having a microarray reader that produces the time-course data that is the starting point for the invention. The system preferably includes a computer system which comprises a number of internal components and is also linked to external components. The internal components include processor element interconnected with main memory. The external components include mass storage, e.g., one or more hard disks (typically of 1 GB or greater storage capacity). Additional external components include user interface device, which can be a keyboard and a monitor including a display screen, together with pointing device, such as a “mouse”, or other graphic input device. The interface allows the user to interact with the computer system, e.g., to cause the execution of particular application programs, to enter inputs such as data and instructions, to receive output, etc. The computer system may further include disk drive, CD drive, and/or other external drive for reading and/or writing information from or to external media respectively. Additional components such as DVD drives, USB ports, etc., are also contemplated.

The computer system is typically connected to one or more network lines or connections, which can be part of an Ethernet link to other local computer systems, remote computer systems, or wide area communication networks, such as the Internet. This network link allows computer system to share data and processing tasks with other computer systems and to communicate with remotely located users. The computer system may also include components such as a display screen, printer, etc., for presenting information, e.g., for displaying graphical representations of gene networks.

A variety of software components, which are typically stored on mass storage, will generally be loaded into memory during operation of the inventive system. These components function in concert to implement the methods described herein. The software components include operating system, which manages the operation of computer system and its network connections, This operating system can be, e.g., a Microsoft Windows™ operating system such as Windows 98, Windows 2000, or Windows NT, a Macintosh operating system, a Unix or Linux operating system, an OS/2 or MS/DOS operating system, etc.

Software component is intended to embody various languages and functions present on the system to enable execution of application programs that implement the inventive methods. Such components, include, for example, language-specific compilers, interpreters, and the like. Any of a wide variety of programming languages may be used to code the methods of the invention. Such languages include, but are not limited to, C (see, for example, Press et al., 1993, Numerical Recipes in C: The Art of Scientific Computing, Cambridge Univ. Press, Cambridge, or the Web site having URL www.nr.com for implementations of various matrix operations in C), C++, Fortran, JAVA™, various languages suitable for development of rule-based expert systems such as are well known in the field of artificial intelligence, etc, According to certain embodiments of the invention the software components include Web browser, for interacting with the World Wide Web.

The software component represents the methods of the present invention as embodied in a programming language of choice, In particular, the software component includes code to accept a set of activity measurements and code to estimate parameters of an approximation to a set of differential equations or difference equations representing a biological network. Included within the latter is code to implement one or more fitness functions, code to implement one, or more search procedures, and code to apply the search procedures. Code to calculate variances and other statistical metrics, as described above, may also be included. Additional software components to display the network model may also be included, According to certain embodiments of the invention a user is allowed to select various among different options for fitness function, search strategy, statistical measures and significance etc. The user may also select various criteria and threshold values for use in identifying major regulators of particular species and/or of the network as a whole. The invention may also include one or more databases, that contains sets of parameters for a plurality of different models, sets of targets for different compounds, sets of phenotypic mediators, etc., statistical package, and other software components such as sequence analysis software, etc.

Thus the invention provides a computer system for constructing a model of a biological network, the computer system comprising: (i) memory that stores a program comprising computer-executable process steps; and (ii) a processor which executes the process steps so as to construct a model of a biological network, the model comprising an approximation to a set of differential equations or a set of difference equations that represent evolution over time of activities of at least one biochemical species in a biological network. According to certain embodiments of the invention the process steps estimate parameters of and select a structure for a model of a biological network. The process steps may perform any of the inventive methods described herein. According to certain aspects of the invention rather than constructing the model, the computer system receives an externally supplied model of a biological network and applies the model to biological data (e.g., activity data), which may be entered by a user. The computer system may use the model and data to, for example, perform sensitivity analysis, identify targets of a perturbation, identify phenotypic mediators, etc. Thus, certain aspects of the invention do not require that the computer system and/or the computer-executable process steps are actually equipped to construct the model.

The invention further provides computer-executable process steps stored on a computer-readable medium, the computer-executable process steps comprising code to perform the methods herein. According to certain embodiments of the invention the computer-executable process steps comprise code to estimate parameters of and select a structure for a model of a biological network. The code may implement any of the inventive methods described herein. The model may displayed or presented to the user in any of a variety of ways. For example, the parameters may be displayed in tables, as matrices, as weights on a graphical representation of the network, etc.

The foregoing description is to be understood as being representative only and is not intended to be limiting. Alternative systems and techniques for implementing the methods of the invention will be apparent to one of skill in the art and are intended to be included within the accompanying claims. In particular, the accompanying claims are intended to include alternative program structures for implementing the methods of this invention that will be readily apparent to one of skill in the art.
[1]H. Li, R. Helling, C. Tang, and N. Wingreen. Science, 273:666-669, 1996.
[2] S. Bornholdt. Science, 310:449-451, 2005.
[3] S. A. Kauffman. Oxford University Press, Oxford, 1993,
[4] F. Li, T. Long, Y. Lu, Q. Ouyang, and C. Tang. Proc. Natl. Acad. Sci. U.S.A., 101:4781-4786, 2004.
[5] K. Lau, S. Ganguli, and C. Tang. Phys. Rev. E, 75:051907, 2007.
[6] Y. D. Nochomovitz and H. Li. Proc. Natl. Acad. Sci. U.S.A., 103:4180-4185, 2006.
[7] R. Albert and H. G. Othmer. J. Theor. Biol., 223:1-18, 2003.
[8] N, Tan and Q. Ouyang. J. Theor. Biol., 240:592-598, 2006.
[9] M. A. Fortuna and C. J. Melian. J. Theor. Biol., 247:331-336, 2007.
[10] Y. Yu, G. Wang, R. Simha, W. Peng, F. Turano, and C. Zeng. PLoS Comput. Biol., 3:el71, 2007.
[11] C. P. Gomes and B. Selman. Science, 297:784-785, 2002.
[12] F. Tripodi, M. Zinzalla, M. Vanoni, L. Alberghina, and P. Coccetti. Biochem. Biophys. Res. Commun., 359:921-927, 2007.
[13] J. R. Skaar and M. Pagano. Nat. Cell Biol., 10:755-757, 2008.
[14] E. Schwob and K. Nasmyth. Genes Dev., 7:1160-1175, 1993.
[15] U. Surana, H. Robitsch, C. Price, T. Schuster, I. Fitch, A. B. Futcher, and K Nasmyth. Cell, 65:145-161, 1991.
[16] M. D. Mendenhall and A. E. Hodge. Microbiol. Mol Biol Rev, 62:1191-1243, 1998.
[17] http://minisat.se/.
[18] M. Isalan, C. Lernerle, K. Michalodimitrakis, C. Horn, R Beltrao, E. Raineri, M. Garriga-Canut, and L. Serrano. Nature, 452:840-845, 2008.
[19] Kashtan N, Alon U (2005) Spontaneous evolution of modularity and network motifs. Proc. Natl. Acad. Sci. U.S.A., 102:13773713778.
[20] Alon U (2006) An Introduction to Systems Biology: Design Principles of Biological Circuits, Chapman & Hall.
[21] Alon U (2007) Network motifs: theory and experimental approaches. Nature Reviews Genetics, 8:450-461.
[22] Dobrin R, Beg Q-K, Barabasi A-L, Oltvai Z-N (2004) Aggregation of topological motifs in the E. coli transcriptional regulatory network, BMC Bioinformatics 5:10.
[23] Albert I, Thakar J, Li S, Zhang R, Albert R (2008) Boolean network simulations for life scientists Source Code for Biology and Medicine.
[24] Assmann S-M, Albert R (2009) Discrete dynamic modeling with asynchronous update or, how to model complex systems in the absence of quantitative information, Methods in Molecular Biology: Plant Systems Biology, D. Belostotsky (ed), Humana Press, NJ.
[25] Davidich, M-I, Bornholdt S (2008) Boolean Network Model Predicts Cell Cycle Sequence of Fission Yeast. PLoS One, 3:el672.
[26] Novak B, Tyson J-J (1997) Modeling the control of DNA replication in fission yeast. Proc. Natl. Acad. Sci. U.S.A., 94:9147-9152.
[27] Novak B, Csikasz-Nagy A, Gyorffy B, Chen K, Tyson J-J (1998) Mathematical model of the fission yeast cell cycle with checkpoint controls at the G1/S, G2/M and metaphase/anaphase transitions. Biophys. Chem., 72:185-200.
[28] Novak B, Pataki Z, Ciliberto A, Tyson J-J (2001) Mathematical model of the cell division cycle of fission yeast. Chaos, 11:277-286.
[29] Sveiczer A, Csikasz-Nagy A, Gyorffy B, Tyson J-J, Novak B (2000) Modeling the fission yeast cell cycle: quantized cycle times in wee1-cdc25Delta mutant cells Proc. Natl. Acad. Sci. U.S.A., 97:7865-7870.
[30] Tyson J-J, Chen K-C, Novak B (2001) Network dynamics and cell physiology. Nature Rev. Mol. Cell Biol., 2:908-916.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A method for obtaining information about a biological network using a logic based approach, comprising the steps of:
storing, in memory, a list of objects, each object representing a biomolecule within a biological network, each biomolecule is in one of two states, an ON state and an OFF state;
storing, in memory, a collection of network states representing a biological process, where each network state comprises of the states of the list of objects;
calculating, using a processor, and outputting a set of all possible Boolean networks (W), from the biological process;
deriving, using the processor, a number of possible networks that produce the given system function or biological process (P) from the set of all possible Boolean networks (W);
deriving, using the processor, all minimal networks (M) by calculating the networks with the smallest number of edges from the number of possible networks, that produce a system function (P);
deriving, using the processor, a number of networks that are irreducible (I) by calculating those networks in P which upon the removal of any edge would result in a network no longer in (P); and
generating output data, using the processor, representing the values of one or more of (W), (P), (M), and (I).

2. The method of claim 1, further comprising the step of identifying, using the processor, recurring structural motifs when the network is decomposed into a minimal network and redundant network, wherein the redundant network can naturally reveal the recurring structural motifs.

3. The method of claim 1, wherein the method allows for current satisfiability solvers, which are algorithms to solve Boolean equations, to be able to solve expressions with millions of variables.

4. Computer readable media implementable in a computer system, comprising: program instructions for carrying out the method of claim 1.

5. The method of claim 1, further comprising receiving the list of objects.

6. The method of claim 1, wherein the biomolecule comprises one of a protein, nucleic acid, carbohydrate, complex thereof, cell organelles and/or cell.

7. The method of claim 1, wherein the system function comprises a biological process.

8. A computer system for obtaining information about a biological network using a logic based approach, comprising:
a memory which stores a list of objects, each object representing a biomolecule within the biological network;
a processor which assigns each biomolecule one of two states, an ON state and an OFF state, calculates the space of all possible Boolean networks from the list of biomolecules of a given state, and generates output data representing a value of the possible Boolean networks.

9. The system of claim 8, wherein the processor further derives the number of possible networks that produce a system function from the space of all possible Boolean networks.

10. The system of claim 9, wherein the processor further derives all minimal networks by calculating the networks with the smallest number of edges from the number of possible networks, that produce a system function.

11. The system of claim 9, wherein the processor further derives the number of networks that are irreducible by calculating those networks in the system function which upon the removal of any edge would result in a network no longer in the system function.

12. The system of claim 11, wherein the processor identifies recurring structural motifs when the network is decomposed into a minimal network and redundant network, wherein the redundant network can naturally reveal the recurring structural motifs.

13. The system of claim 11, wherein the method allows for current satisfiability solvers to be able to solve expressions with millions of variables.

14. The system of claim 13, wherein said current satisfiability solvers comprise software programs which solve Boolean equations.

15. A computer system for obtaining information about a biological network using a logic based approach, comprising:
a memory which stores a list of objects, each object representing a biomolecule within the biological network;
a processor which assigns each biomolecule one of two states, an ON state and an OFF state, derives the number of possible networks that produce a system function from the space of all possible Boolean networks, and generates output data representing a value of the system function.

16. A computer system for obtaining information about a biological network using a logic based approach, comprising:
a memory which stores a list of objects, each object representing a biomolecule within the biological network;
a processor which assigns each biomolecule one of two states, an ON state and an OFF state, derives all minimal networks by calculating the networks with the smallest number of edges from the number of possible networks, that produce a system function, and generates output data representing a value of the minimal networks.

17. A computer system for obtaining information about a biological network using a logic based approach, comprising:
a memory which stores a list of objects, each object representing a biomolecule within the biological network;
a processor which assigns each biomolecule one of two states, an ON state and an OFF state, derives a number of networks that are irreducible by calculating those networks in a system function which upon the removal of any edge would result in a network no longer in the system function, and generates output data representing a value of the number of networks that are irreducible.
